(19) United States
(12) Patent Application Publication
(10) Pub. No.: US 2026/0198479 A1
(43) Pub. Date: Jul. 16, 2026

(54) ANIMAL DETERRENT DEVICE

(71) Applicant: Dabos, Inc., Rockville, MD (US)

(72) Inventor: David McNairy, Rockville, MD (US)

(73) Assignee: Dabos, Inc., Rockville, MD (US)

(21) Appl. No.: 19/020,198

(22) Filed: Jan. 14, 2025

(51) Int. Cl. A01M 29/10; A01M 29/16

(52) U.S. Cl. CPC A01M 29/10; A01M 29/18

(57) ABSTRACT

A device to deter an animal, the device comprising a laser diode that is configured to emit laser, a transducer that is configured to emit an audible sound above 20 Kilohertz (KHz), a depressible button that is configured to be depressed by the user, and a micro controller coupled to the laser diode, the transducer and the depressible button, the micro controller is configured to detect the user depressing the depressible button, and activate the laser diode and the transducer in response to the depression of the depressible button to deter the animal.

### FIELD OF THE INVENTION

The present invention relates to an animal deterrent device intended to deter a canine, for example.

### BACKGROUND OF THE INVENTION

Mail carriers and other delivery service providers often face animal obstructions that prevent them from completing their work. Parents face challenges in protecting their children in communities where pets have minimal restrictions, for example. Employees in zoos and other animal facilities are also in environments with wild animals that can impact their health and safety. Thus, there remains a need to develop an improved animal deterrent device that is simple, versatile and effective to ward off animals and improve safety and health to the user.

### SUMMARY OF EMBODIMENTS OF THE INVENTION

It is an aspect of the present invention to provide a device to deter an animal, the device comprising a laser diode that is configured to emit laser, a transducer that is configured to emit an audible sound above 20 Kilohertz (KHz), a depressible button that is configured to be depressed by the user, and a controller coupled to the laser diode, the transducer and the depressible button, the controller is configured to detect the user depressing the depressible button, and activate the laser diode and the transducer in response to the depression of the depressible button to deter the animal.

Another aspect of the present invention is to provide a method of operating a device to deter an animal, the method comprising the steps of depressing a button to initiate operation of the device, and programming a controller to perform the following detecting the depression of the button, activating an enable switch based on the detection, instructing a driver transformer based on the activated enable switch to provide electrical power to a front circuit card assembly, emitting a laser via a laser diode in the front circuit card assembly, and emitting an audible sound above 20 Kilohertz (KHz) via a transducer in the front circuit card assembly.

A further aspect of the present invention is to provide a method of operating a device to deter an animal, the method comprising the steps of detecting the depression of a button, activating a laser via a laser diode in response to detecting the button being depressed, and activating an audible sound above 20 Kilohertz (KHz) via a transducer in response to detecting the button being depressed.

An additional aspect of the present invention is to provide a non-transitory computer readable media storing instructions that are executable by a processor to cause a processing device to execute operations comprising detect the depression of a button, activate a laser via a laser diode in response to detecting the button being depressed, and activate an audible sound above 20 Kilohertz (KHz) via a transducer in response to detecting the button being depressed.

Additional and/or other aspects and advantages of the present invention will be set forth in the description that follows, or will be apparent from the description, or may be learned by practice of the invention.

### BRIEF DESCRIPTION OF THE DRAWINGS

The above and/or other aspects and advantages of embodiments of the invention will be more readily appreciated from the following detailed description, taken in conjunction with the accompanying drawings. The drawings described herein are for illustrative purposes only of selected embodiments and not all possible implementations, and are not intended to limit the scope of the present disclosure.

FIG. 1 illustrates a perspective view of an animal deterrent device according to an exemplary embodiment of the present invention;

FIG. 2 illustrates an exploded view of the animal deterrent device of FIG. 1;

FIG. 3 illustrates a block diagram of the animal deterrent device of FIG. 1; and

FIG. 4 illustrates exemplary steps of a method of operating the animal deterrent device of FIG. 1.

### DETAILED DESCRIPTION

Reference will now be made in detail to embodiments of the present invention, which are illustrated in the accompanying drawings, wherein like reference numerals refer to like elements throughout. The embodiments described herein exemplify, but do not limit, the present invention by referring to the drawings. In some instances, certain circuits, structures and techniques have not been described or shown in detail in order not to obscure the disclosure. The embodiments are not intended to be mutually exclusive so that the features of one embodiment can be combined with other embodiments as long as they do not contradict each other.

It will be understood by one skilled in the art that this disclosure is not limited in its application to the details of construction and the arrangement of components set forth in the following description or illustrated in the drawings. The embodiments herein are capable of other embodiments, and capable of being practiced or carried out in various ways. Phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless limited otherwise, the terms “connected,” “coupled,” and “mounted,” and variations thereof herein are used broadly and encompass direct and indirect connections, couplings, and mountings. In addition, the terms “connected” and “coupled”” and variations thereof are not restricted to physical or mechanical connections or couplings. Further, terms such as “up,” “down,” “bottom,” “top,” “front,” “rear,” “upper,” “lower,” “upwardly,” “downwardly,” and other orientational descriptors are intended to facilitate the description of the exemplary embodiments of the present invention, and are not intended to limit the structure of the exemplary embodiments of the present invention to any particular position or orientation. Terms of degree, such as “substantially” or “approximately” are understood by those skilled in the art to refer to reasonable ranges around and including the given value and ranges outside the given value, for example, general tolerances associated with manufacturing, assembly, and use of the embodiments. The term “substantially” when referring to a structure or characteristic includes the characteristic that is mostly or entirely.

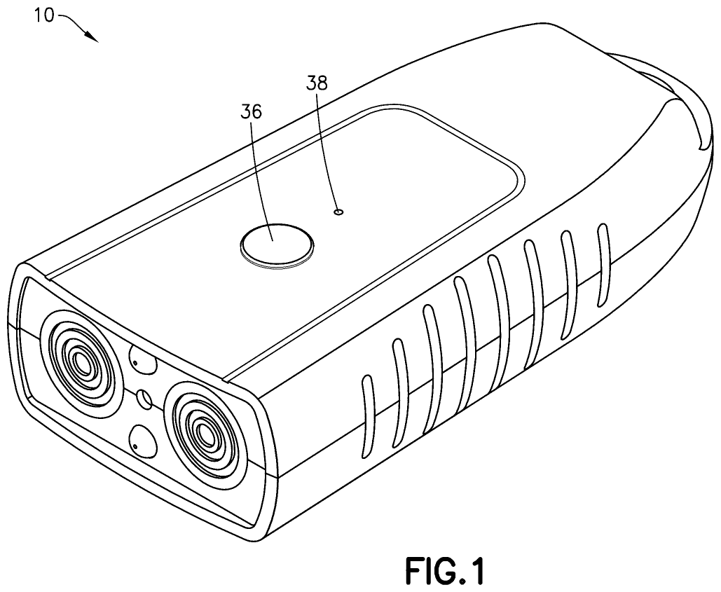

FIG. 1 illustrates a perspective view of an animal deterrent device 10. The animal deterrent device 10 is specifically used to deter canines but can be used for other animals and in other situations as well. For example, mail carriers and other delivery service providers often experience obstructions from canines that prevent them from completing their work. Parents face challenges in protecting their children in canine friendly communities. Zoologists and other employees at the zoo and animal shelters, for example, also need to protect their health and safety from wild animals.

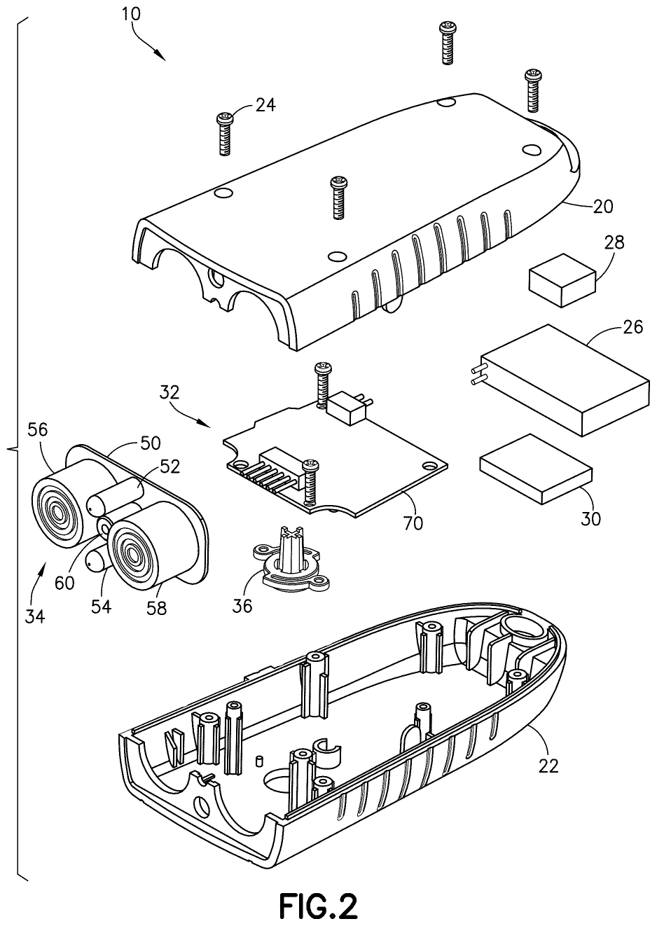

FIG. 2 illustrates an exploded view of the animal deterrent device 10. The animal deterrent device 10 includes a top housing 22 and a bottom housing 20 secured by screws 24 to enclose the components of the animal deterrent device 10. The top housing 22 and the bottom housing 20 are preferably injection molded components but plastics and other materials like polyethylene are also contemplated and understood by one skilled in the art.

The animal deterrent device 10 further includes a battery 26, a main circuit card assembly 32, a front circuit card assembly 34, a button 36 and a hole 38 in the top housing 22. The battery 26 provides electrical power to the animal deterrent device 10. The battery 26 is sandwiched between a first battery foam sheet 28 and a second battery foam sheet 30 to secure and protect the battery 26. Specifically, when the animal deterrent device 10 is jostled or dropped, for example, the first battery foam sheet 28 and the second battery foam sheet 30 advantageously secure the battery 26 and prevent the battery 26 from moving and from being damaged inside the top and bottom housing 20, 22. The first and second battery foam sheet 28, 30 are able to absorb any impact force or other extraneous force applied to the animal deterrent device 10 to isolate and protect the battery 26. It is contemplated by one skilled in the art that other impact absorbing materials can replace the first and second battery foam sheets 28, 30.

FIGS. 1 and 2 illustrate the button 36 preferably being a depressible push button assembly without a spring that is configured to be depressed by a user and cooperates with the main circuit card assembly 32. The button 36 initiates operation of the animal deterrent device 10 as further described below. Other button mechanisms such as a spring-loaded push button assembly are contemplated herein and understood by one skilled in the art.

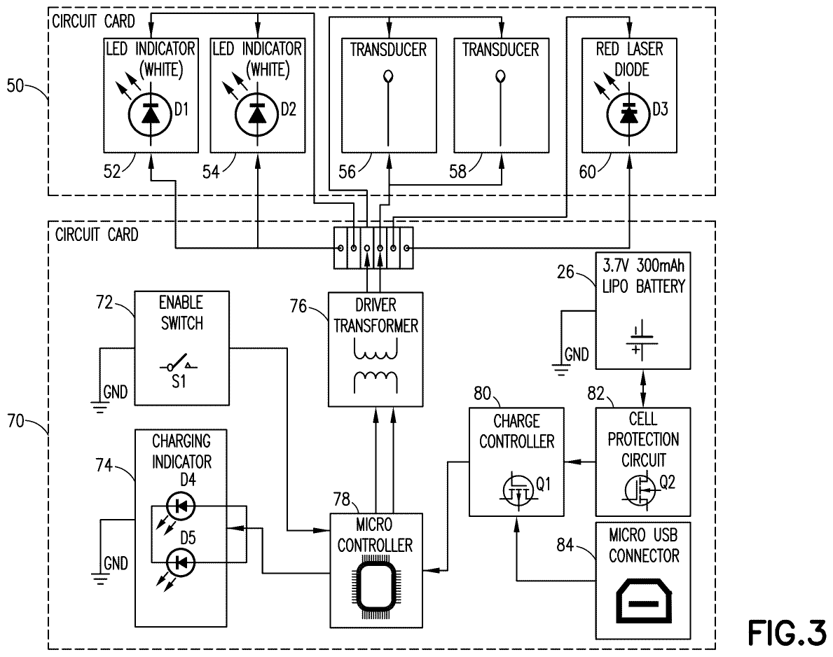

FIG. 2 further illustrates the front circuit card assembly 34 having a first circuit board 50 and the main circuit card assembly 32 having a second circuit board 70. FIG. 3 further illustrates the details of the first circuit board 50 and the second circuit board 70. The first circuit board 50 includes a first LED indicator 52 and a second LED indicator 54. The first and second LED indicators 52, 54 illuminate white light and are able to advantageously deter and distract a canine during operation. The first and second LED indicators 52, 54 are aligned on a vertical axis of the first circuit board 50 on the front circuit card assembly 34. Although two LED indicators 52, 54 are preferred, the first circuit board 50 can include only one LED indicator or more than two LED indicators as understood by one skilled in the art.

The first circuit board 50 further includes a first transducer 56 and a second transducer 58. The first and second transducers 56, 58 are aligned on a horizontal axis of the first circuit board 50 on the front circuit card assembly 34. The first and second transducers 56, 58 emit a high frequency audible sound to advantageously deter and distract the animal during operation. Specifically, the frequency of the audible sound is preferably above 20 kilohertz (KHz). More preferably, the frequency of the audible sound is equal to or above 30 KHz. The first and second transducers 56, 58 operate either alone or preferably in combination with the first and second LED indicators 52, 54 to optimize the deterrence effect to the animal. Although two transducers 56, 58 are preferred, the first circuit board 50 can include only one transducer or more than two transducers as understood by one skilled in the art.

Finally, the first circuit board 50 includes a red laser diode 60. The red laser diode 60 preferably emits a Food and Drug Administration (FDA) class 3a laser, although the use of other lasers in different FDA classes are contemplated herein and understood by one skilled in the art. The red laser diode 60 is preferably aligned and disposed between the first LED indicator 52 and the second LED indicator 54 on a vertical axis of the first circuit board 50 on the front circuit card assembly 34. The red laser diode 60 and the first and second LED indicators 52, 54 are also disposed between the first and second transducers 56, 58. The positioning of the red laser diode 60 between the first and second LED indicators 52, 54 advantageously allows the overlapping of a red laser light and the white light to create a combined light used to ward off or deter animals.

The red laser diode 60 operates either alone, in combination with the first and second LED indicators 52, 54, in combination with the first and second transducers 56, 58 or preferably in combination with the first and second LED indicators 52, 54 and the first and second transducers 56, 58 to optimize the deterrence effect to the animal. In the preferred embodiment, the button 36 is depressed by the user and the red laser diode 60, the first and second transducers 56, 58 and the first and second LED indicators 52, 54 are all activated.

In another embodiment, depressing the button 36 multiple times allows the user to toggle through various configurations programmed into a micro controller 78. As illustrated in FIGS. 1 and 2, each of the components of the first circuit board 50 are disposed in the front circuit card assembly 34 for the user to advantageously direct the emission of the light, laser and sound to the animal.

FIG. 2 illustrates the second circuit board 70 fixed to the top housing 22 via screws 24. FIG. 3 illustrates that the second circuit board 70 is electrically connected to each of the components in the first circuit board 50 as described above. The second circuit board 70 includes an enable switch 72, a charging indicator 74, a driver transformer 76, the micro controller 78, a charge controller 80, a cell protection circuit 82 and a micro USB connector 84. These components are further described below.

The enable switch 72 is switched when the user depresses the button 36. When the button 36 is depressed, the enable switch 72 notifies the micro controller 78 to initiate operation of the animal deterrent device 10.

The charging indicator 74 provides a visual cue when the battery 26 is being charged. Specifically, an external power source is connected to the animal deterrent device 10 via the micro USB connector 84. The charge controller 80 is configured to receive a supply voltage from the external power source via the micro USB connector 84. Subsequently, the charge controller 80 provides a charging voltage to the battery 26 through a cell protection circuit 82.

The cell protection circuit 82 is an electronic safety mechanism designed to ensure the safe operation of the cells in the battery 26. The cell protection circuit 82 prevents damage to the cells due to conditions like overcharging, over-discharging, over-current, or short-circuiting, for example. While the battery 26 receives a charging voltage, the charging indicator 74 illuminates. Light from the charging indicator 74 passes through the hole 38 in the top housing 22. In this manner, the user is alerted when the battery 26 in the animal deterrent device 10 is being charged.

The micro controller 78 performs various functions in the animal deterrent device 10. The micro controller 78 receives electrical power from the battery 26 via the cell protection circuit 82 and the charge controller 80. When the button 36 is depressed, the enable switch 72 notifies the micro microcontroller 78 to initiate operation of the animal deterrent device 10. Specifically, signals in the form of an input voltage from the micro controller 78 are transformed by the driver transformer 76 to initiate operation of the components in the first circuit board 50 of the front circuit card assembly 34. More specifically, the driver transformer 76 is coupled to the micro controller 78 and the battery 26, and is preferably configured to convert the input voltage from the micro controller 78 to an output voltage used to simultaneously power (1) the laser diode 60 to emit the red laser, (2) the first and second LED indicators 52, 54 to emit the white light, and (3) the first and second transducers 56, 58 to emit the audible sound.

In a preferred embodiment, the micro controller 78 is configured to control the first transducer 56 and the second transducer 58 to operate simultaneously at a specified wavelength above 20 Kilohertz (KHz). More preferably, the frequency of the audible sound is equal to or above 30 KHz. This is illustrated by modifying FIG. 3 to provide a single line between the micro controller 78 and the driver transformer 76.

In one embodiment, the micro controller 78 is configured to control the first transducer 56 and the second transducer 58 independently. This is illustrated in FIG. 3 by two lines between the micro controller 78 and the driver transformer 76 acting as individual inputs for each transducer 56, 58. Furthermore, although the driver transformer 76 is shown as a single block, it should be appreciated that more than one driver transformer 76 may be used for the independent operation of the first transducer 56 and the second transducer 58 (e.g., one driver transformer 76 to each of the individual inputs from the micro controller 78). The user could, for example, depress the button 36 multiple times to toggle through various configurations programmed into the micro controller 78. Specifically, the first depression of the button 36 emits a sound from the first transducer 56. The second depression of the button 36 emits a sound from the second transducer 58. The third depression of the button 36 emits a sound from both of the transducers 56, 58 simultaneously. This toggling could repeat the different modes as the button 36 continues to be depressed.

In this manner, the micro controller 78 is able to vary a frequency of the first audible sound from the first transducer 56 and a frequency of the second audible sound from the second transducer 58. For example, the first transducer 56 is configured to emit an audible sound at 30 KHz and the second transducer 58 is configured to emit an audible sound at 40 KHz. The frequency of the audible sounds from each of the transducers 56, 58 could be preset prior to assembly. Compounding the two audible sounds at different frequencies can advantageously create an uncomfortable sound for the animal and can also expand the effect of the sound to other animals.

In another embodiment, the micro controller 78 is configured to control the first transducer 56 and the second transducer 58 to sweep at least one of a frequency range of frequencies or an amplitude range of amplitudes of the first audible sound emitted by the first transducer 56 and the second audible sound emitted by the second transducer 58. The frequency range controls the pitch of the audible sound and the amplitude range controls the volume of the audible sound. In this manner, the frequency range and the amplitude range selected can advantageously account for differing hearing abilities of members of a population of the animal. The user could, for example, depress the button 36 multiple times to toggle through different pitch settings and different amplitude settings programmed into the micro controller 78.

In another embodiment, the controller is configured to control a first frequency of the first audible sound emitted from the first transducer 56 and a second frequency of the second audible sound emitted from the second transducer 58. As a result, a combined audible sound including the first audible sound and the second audible sound creates a beat. The animal can hear at least one of the first frequency, the second frequency, or a beat frequency of the beat to deter the animal. Again, the user could, for example, depress the button 36 multiple times to toggle through the three frequency settings described above and programmed into the micro controller 78. This configuration advantageously provides versatility to the animal deterrent device 10 such that multiple animals can now be deterred.

In a preferred embodiment, when an external power source is connected to the animal deterrent device 10 via the micro USB connector 84, the charge controller 80 is configured to receive a supply voltage from the external power source via the micro USB connector 84 and the micro controller 78 is notified. Subsequently, the charge controller 80 provides a charging voltage to the battery 26 through a cell protection circuit 82 to charge the battery 26. At the same time, the micro controller 78 instructs the charging indicator 74 to provide a visual cue (light) through the hole 38 in the top housing 22 notifying the user that the battery 26 is charging.

Similar to the independent control of the first transducer 56 and the second transducer 58 by the micro controller 78 at different frequencies, sweeping frequency ranges, etc., the micro controller 78 may also be configured to turn the laser diode 60 and/or first and second LED indicators 52, 54 on and off (i.e., blink or flash) at different frequencies, sweep frequency ranges, etc. The frequency of such blinking or flashing may be selected to be unpleasant to the animal and/or temporarily stun the animal.

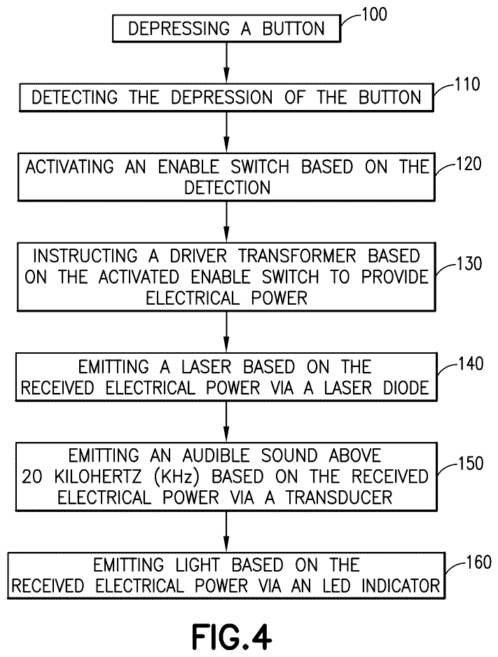

FIG. 4 illustrates steps of a method of operating the animal deterrent device 10. The first step 100 for operating the animal deterrent device 10 is a user depressing the button 36. Depressing the button 36 initiates the operation of the animal deterrent device 10. The next step 110 is the animal deterrent device 10 detecting the depression of the button 36. This detection is performed by the enable switch 72 that is coupled to the button 36.

This detection takes place by activating the enable switch 72 as identified in the next step 120. The enable switch 72 notifies the micro controller 78 when the button 36 is depressed. Next, step 130 involves the micro controller 78 instructing the driver transformer 76 based on the activated enable switch 72 to provide electric power via the battery 26. The battery 26 is coupled to the micro controller 78 to selectively provide power to the components in the animal deterrent device 10.

Specifically, the following steps 140, 150, 160 involve the micro controller 78 operating the components in the first circuit board 50 of the front circuit card assembly 34. Step 140 involves emitting a red laser via the laser diode 60 based on the received electrical power from the battery 26. Step 150 involves emitting an audible sound above 20 KHz via the first and second transducers 56, 58 based on the received electrical power from the battery 26. Preferably, the frequency of the audible sound is equal to or above 30 KHz. Step 160 involves emitting white light via the first and second LED indicator 52, 54 based on the received electrical power from the battery 26.

As described above, steps 140, 150, 160 can preferably occur simultaneously. However, other embodiments allow for these steps to take place independently or performing two of these steps simultaneously, for example, steps 140 and 150, steps 150 and 160 or steps 140 and 160. The user could, for example, depress the button 36 multiple times allows to toggle through the independent and simultaneous combinations described above that are programmed into the micro controller 78.

In another embodiment, the method steps of FIG. 4 can be simplified to be a method of operating a device to deter an animal, the method comprising the steps of detecting the depression of a button, activating a laser via a laser diode in response to detecting the button being depressed, and activating an audible sound above 20 Kilohertz (KHz) via a transducer in response to detecting the button being depressed. Various method steps of the animal deterrent device 10 and the micro controller 78 disclosed herein can be incorporated into this embodiment.

In another embodiment, the micro controller 78 is configured to controlling the first transducer 56 and the second transducer 58 to sweep at least one of a frequency range of frequencies or an amplitude range of amplitudes of the first audible sound emitted by the first transducer 56 and the second audible sound emitted by the second transducer 58. The user could, for example, depress the button 36 multiple times to toggle through different pitch settings and different amplitude settings programmed into the micro controller 78.

In another embodiment, the micro controller 78 is configured to controlling a first frequency of the first audible sound emitted from the first transducer 56 and a second frequency of the second audible sound emitted from the second transducer 58 such that the combined audible sound comprising the first audible sound and the second audible sound creates the beat that is perceived by the animal. Again, the user could, for example, depress the button 36 multiple times to toggle through the three frequency settings described above and programmed into the micro controller 78.

The following steps allow for recharging the animal deterrent device 10. When an external power source is engaging the micro USB connector 84, the charge controller 80 is configured to receiving a supply voltage from the micro USB connector 84 and is configured to providing a charging voltage to the battery 26 through the cell protection circuit 82. As a result, the charge controller 80 notifies the micro controller 78 of the battery 26 charging. The micro controller 78 then notifies the charging indicator 74 that the battery 26 is charging. Subsequently, the animal deterrent device 10 is configured to alerting the user via a light expressed in the hole 38 in the top housing 22. The light acts as a visual cue emitted from the charging indicator 74 when the battery 26 is being charged.

In another embodiment, a non-transitory computer readable media storing instructions that are executable by a processor (or micro controller 78) to cause a processing device to execute operations comprises detect the depression of a button, activate a laser via a laser diode in response to detecting the button being depressed, and activate an audible sound above 20 Kilohertz (KHz) via a transducer in response to detecting the button being depressed. Various method steps of the animal deterrent device 10 and the micro controller 78 disclosed herein can be stored as instructions in the non-transitory computer readable media that are executable by the processor or micro controller 78 and incorporated into this embodiment.

Although only a few embodiments of the present invention have been shown and described, the present invention is not limited to the described embodiments. It will be appreciated by those skilled in the art that other changes may also be made to the disclosed embodiments without departing from the scope of the invention. In addition, any of the embodiments, features and/or elements disclosed herein may be combined with one another to form various additional combinations not specifically disclosed, as long as the embodiments, features and/or elements being combined do not contradict each other. All such changes and combinations are considered to be within the scope of the invention as defined by the appended claims and their equivalents. Unless the phrase “means for” is used in the claims, no language in the specification or the claims is intended to invoke 35 U.S.C. 112(f).

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented as a collection of instructions executed by a processing device, for example, as a computer program product such as a computer program, program code or computer instructions tangibly embodied in an information carrier, or in a machine-readable storage device, for execution by, or to control the operation of, data processing apparatus such as a programmable processor, a microprocessor, a computer, or multiple computers. The term “micro controller” or “controller” as used in this application is comprehensive of any such computer, processor, microchip processor, integrated circuit, or any other element(s), whether singly or in multiple parts, capable of carrying programming for performing the functions, methods and flowcharts provided herein. The micro controller may be a single such element which is resident on a printed circuit board with the other electronic elements. It may, alternatively, reside remotely from the other elements systems described herein. For example, but without limitation, the at least one controller may take the form of programming in the onboard computer of a vehicle within the door, a latch or at other locations within the vehicle as examples. The micro controller may also reside in multiple locations or comprise multiple components.

A list of instructions, for example a computer program, can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network. Also, functional programs, codes, and code segments for accomplishing the illustrative embodiments can be easily construed as within the scope of claims exemplified by the illustrative embodiments by programmers skilled in the art to which the illustrative embodiments pertain. Method steps associated with the illustrative embodiments can be performed by one or more programmable processors executing a computer program, code or instructions to perform functions (e.g., by operating on input data and/or generating an output). Method steps can also be performed by, and apparatus of the illustrative embodiments can be implemented as, special purpose logic circuitry, e.g., an FPGA (field programmable gate array) or an ASIC (application-specific integrated circuit), for example.

The various illustrative logical blocks, modules, algorithms, steps, and circuits described in connection with the embodiments disclosed herein may be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, microcontroller, or state machine, as examples. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, algorithms, and steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of claims exemplified by the illustrative embodiments. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In other words, the processor and the storage medium may reside in an integrated circuit or be implemented as discrete components.

Computer-readable non-transitory media includes all types of computer readable media, including magnetic storage media, optical storage media, flash media and solid state storage media. It should be understood that software can be installed in and sold with a central processing unit (CPU) device. Alternatively, the software can be obtained and loaded into the CPU device, including obtaining the software through physical medium or distribution system, including, for example, from a server owned by the software creator or from a server not owned but used by the software creator. The software can be stored on a server for distribution over the Internet, for example.

1. A device to deter an animal, the device comprising:
a front circuit card assembly including:
a laser diode that is configured to emit a laser;
a first light emitting diode (LED) indicator and a second LED indicator that are aligned on a vertical axis of the front circuit card assembly with the laser diode disposed between the first and second LED indicators on the front circuit card assembly; and
a first transducer and a second transducer that are aligned on a horizontal axis of the front circuit card assembly, the first transducer and the second transducer each configured to emit an audible sound above 20 Kilohertz (KHz);
a depressible button that is configured to be depressed by a user; and
a micro controller coupled to the laser diode, the first transducer and the second transducer, the first LED indicator and the second LED indicator and the depressible button, the micro controller is configured to:
detect the user depressing the depressible button, and
activate the laser diode and the first transducer and the second transducer in response to the depression of the depressible button to deter the animal.

2. The device according to claim 1, further comprising a driver transformer coupled to the micro controller and configured to convert an input voltage from the micro controller to an output voltage to the laser diode to emit the laser and to the first transducer and the second transducer to emit the audible sound.

3. The device according to claim 2, further comprising
the first light emitting diode (LED) indicator and the second LED indicator are configured to emit light; wherein
the driver transformer is configured to provide electrical power to the first LED indicator and the second LED indicator to emit white light.

4. The device according to claim 2, further comprising
a battery that provides electrical power to the device via the driver transformer;
a micro USB connector that is configured to connect to an external power source to charge the battery; and
a charge controller configured to receive a supply voltage from the external power source via the micro USB connector and provide a charging voltage to the battery through a cell protection circuit.

5. The device according to claim 4, further comprising a charging indicator that provides a visual cue when the battery is being charged.

6. The device according to claim 5, further comprising a main circuit card assembly including an enable switch, the charging indicator, the driver transformer, the micro controller, the charge controller, the micro USB connector and the cell protection circuit.

7. The device according to claim 4, further comprising a first battery foam sheet and a second battery foam sheet that sandwiches the battery.

8-9. (canceled)

10. The device according to claim 1, wherein
the audible sound includes a first audible sound from the first transducer and a second audible sound from the second transducer; and
the micro controller is further configured to control the first transducer and the second transducer to independently vary the first audible sound from the first transducer and the second audible sound from the second transducer in a controlled manner.

11. The device according to claim 10, wherein
the micro controller is further configured to control the first transducer and the second transducer to sweep at least one of a frequency range of frequencies or an amplitude range of amplitudes of the first audible sound emitted by the first transducer and the second audible sound emitted by the second transducer; and
the frequency range and/or the amplitude range that is selected account for differing hearing abilities of members of a population of the animal.

12. The device according to claim 10, wherein
the micro controller is further configured to control a first frequency of the first audible sound emitted from the first transducer and a second frequency of the second audible sound emitted from the second transducer such that a combined audible sound comprising the first audible sound and the second audible sound creates a beat that is perceived by the animal; and
at least one of the first frequency, the second frequency, or a beat frequency of the beat is selected to deter the animal.

13. A method of operating a device to deter an animal, the method comprising the steps of:
depressing a button to initiate operation of the device; and
programming a micro controller to perform the following:
detecting, via an enable switch coupled to the button, the depression of the button;
receiving, at the micro controller, a notification from the enable switch to initiate operation;
instructing a driver transformer based on the activated enable switch to provide electrical power to a front circuit card assembly;
emitting a laser via a laser diode in the front circuit card assembly; and
emitting an audible sound above 20 Kilohertz (KHz) via at least one transducer in the front circuit card assembly.

14. The method of claim 13, further comprising the steps of:
emitting white light via at least one LED indicator in the front circuit card assembly.

15. The method of claim 13, further comprising the steps of:
receiving, via a charge controller, a supply voltage from a micro USB connector and providing a charging voltage to a battery through a cell protection circuit.

16. The method of claim 15, further comprising the steps of:
alerting a user via a visual cue from a charging indicator when the battery is being charged.

17. The method of claim 13, further comprising the steps of:
converting an input voltage from the micro controller to an output voltage to the laser diode to emit the laser and to the at least one transducer to emit the audible sound.

18. The method of claim 13, further comprising the steps of:
controlling the at least one transducer comprising a first transducer and a second transducer to independently vary a first audible sound from the first transducer and a second audible sound from the second transducer.

19. The method of claim 13, further comprising the steps of:
controlling the at least one transducer comprising a first transducer and a second transducer to sweep at least one of a frequency range of frequencies or an amplitude range of amplitudes of a first audible sound emitted by the first transducer and a second audible sound emitted by the second transducer; and
the frequency range and the amplitude range selected to account for differing hearing abilities of members of a population of the animal.

20. The method of claim 13, further comprising the steps of:
providing the at least one transducer including a first transducer and a second transducer;
controlling a first frequency of a first audible sound emitted from the first transducer and a second frequency of a second audible sound emitted from the second transducer such that a combined audible sound comprising the first audible sound and the second audible sound creates a beat that is perceived by the animal; and
at least one of the first frequency, the second frequency, or a beat frequency of the beat is selected to deter the animal.

21. A method of operating a device to deter an animal, the method comprising the steps of:
detecting the depression of a button;
instructing a driver transformer to provide electric power to a front circuit card assembly based on detecting the depression of the button;
activating an audible sound above 20 Kilohertz (KHz) via at least one transducer in response to detecting the button being depressed; and
simultaneously activating a laser via a laser diode and activating the audible sound above 20 Kilohertz (KHz) via the at least one transducer in the front circuit card assembly in response to detecting the button being depressed.

22. A non-transitory computer readable media storing instructions that are executable by a processor to cause a processing device to execute operations comprising:
detect the depression of a button;
instruct a driver transformer to provide electric power to a front circuit card assembly based on detecting the depression of the button;
activate a laser via a laser diode in response to detecting the button being depressed;
emitting white light via a first LED indicator and a second LED indicator;
activate an audible sound above 20 Kilohertz (KHz) via at least one transducer in the front circuit card assembly in response to detecting the button being depressed; and
simultaneously activating the laser via the laser diode, activating the white light via the first LED indicator and the second LED indicator, and activating the audible sound above 20 Kilohertz (KHz) via the at least one transducer in the front circuit card assembly in response to detecting the button being depressed.

23. The method of claim 13, further comprising the steps of emitting the laser and ultrasonic sound in response to the driver transformer being instructed to power the front circuit card assembly.
